(19) United States
(12) Patent Application Publication
(10) Pub. No.: US 2016/0350336 A1
(43) Pub. Date: Dec. 1, 2016

(54) AUTOMATED IMAGE SEARCHING, EXPLORATION AND DISCOVERY

(71) Applicant: Allyke, Inc., Wellesley, MA (US)

(72) Inventors: Neal Checka, Waltham, MA (US); C. Mario Christoudias, Point Pleasant Beach, NJ (US); Harsha Rajendra Prasad, Arlington, MA (US)

(21) Appl. No.: 15/167,189

(22) Filed: May 27, 2016

Related U.S. Application Data
(60) Provisional application No. 62/168,849, filed on May 31, 2015.
(60) Provisional application No. 62/221,156, filed on Sep. 21, 2015.
(60) Provisional application No. 62/260,666, filed on Nov. 30, 2015.
(60) Provisional application No. 62/312,249, filed on Mar. 23, 2016.

(51) Int. Cl. G06F 17/30; G06K 9/62

(52) U.S. Cl. CPC G06F 17/30268; G06K 9/6215; G06K 9/6285

(57) ABSTRACT

A method is provided for processing image data using a computer system. This method includes: receiving a plurality of image descriptors, each of the image descriptors representing a unique visual characteristic; receiving image data representative of a primary image; processing the image data to select a first subset of the image descriptors that represent a plurality of visual characteristics of the primary image; receiving an image dataset representative of a plurality of secondary images; and processing the image dataset based on the first subset of the image descriptors to determine which of the secondary images are visually similar to the primary image.

### CROSS-REFERENCE TO RELATED APPLICATIONS

This application claims priority to U.S. Provisional Application No. 62/168,849 filed on May 31, 2015, U.S. Provisional Application No. 62/221,156 filed on Sep. 21, 2015, U.S. Provisional Application No. 62/260,666 filed on Nov. 30, 2015 and U.S. Provisional Application No. 62/312,249 filed on Mar. 23, 2016, each of which is hereby incorporated herein by reference in its entirety.

### BACKGROUND OF THE INVENTION

1. Technical Field

This disclosure relates generally to image processing.

2. Background Information

Various image processing methods are known in the art. Typically, such image processing methods require human intervention. For example, a human may need to assign descriptors and/or labels to the images being processed. This can be time consuming and expensive. There is a need in the art for improved systems and methods for processing image data.

### SUMMARY OF THE DISCLOSURE

According to an aspect of the present disclosure, a method is provided for processing image data using a computer system. During this method, a plurality of image descriptors are received. Each of these image descriptors represents a unique visual characteristic. Image data is received, which image data is representative of a primary image. The image data is processed to select a first subset of the image descriptors that represent a plurality of visual characteristics of the primary image. An image dataset is received, which image dataset is representative of a plurality of secondary images. The image dataset is processed based on the first subset of the image descriptors to determine which of the secondary images are visually similar to the primary image. The processing of the image data and the image dataset is autonomously performed by the computer system.

According to another aspect of the present disclosure, a method is provided for processing image data using a computer system and a plurality of image descriptors, where each of the image descriptors represents a unique visual characteristic. During this method, image data is autonomously processed, using the computer system, to select a first subset of the image descriptors that represent a plurality of visual characteristics of a primary image. The image data is representative of the primary image. An image dataset is obtained that is representative of a plurality of secondary images. The image dataset is autonomously processed, using the computer system, to determine a subset of the secondary images. The subset of the secondary images is provided based on the first subset of the image descriptors. The subset of the secondary images are visually similar to the primary image.

According to still another aspect of the present disclosure, a computer system is provided for processing image data. This computer system includes a processing system and a non-transitory computer-readable medium in signal communication with the processing system. The non-transitory computer-readable medium has encoded thereon computer-executable instructions that when executed by the processing system enable: receiving a plurality of image descriptors, each of the image descriptors representing a unique visual characteristic; receiving image data representative of a primary image; autonomously processing the image data to select a first subset of the image descriptors that represent a plurality of visual characteristics of the primary image; receiving an image dataset representative of a plurality of secondary images; and autonomously processing the image dataset based on the first subset of the image descriptors to determine which of the secondary images are visually similar to the primary image.

The foregoing features and the operation of the invention will become more apparent in light of the following description and the accompanying drawings.

### BRIEF DESCRIPTION OF THE DRAWINGS

FIG. 1 is a graphical representation of a transfer learning technique.

FIG. 2 is a graphical representation of search results (left side) provided for respective specimen images (right side).

FIG. 3 is a graphical representation of a spatial transformer.

FIG. 4 is a graphical representation of feature grouping with a non-linear transformation.

FIG. 5 is a graphical representation of a visual similarity search performed within the same example set (top) and across different imaging conditions (bottom).

FIG. 6 is a graphical representation of a tagging process.

FIGS. 7 and 8 are screenshots of re-ranking search results based on color and shape.

FIG. 9 is a flow diagram of a method using visual exemplar processing.

FIGS. 10-12 are a graphical representation of visual clustering.

FIG. 13 is a conceptual visualization of an output after visual clustering.

FIG. 14 is a conceptual visualization of how a visual search can be combined with text based queries.

FIG. 15 is a schematic representation of smart visual browsing.

FIG. 16 is a flow diagram of a method for processing image data.

FIG. 17 is a schematic representation of a computer system.

### DETAILED DESCRIPTION OF THE INVENTION

The present disclosure includes methods and systems for processing image data and image datasets. Large image datasets, for example, may be analyzed utilizing modified deep learning processing, which technique may be referred to as “ALADDIN” (Analysis of LArge Image Datasets via Deep LearnINg). Such modified deep learning processing can be used to learn a hierarchy of features that unveils salient feature patterns and hidden structure in image data. These features may also be referred to as “image descriptors” herein as each feature may be compiled together to provide a description of an image or images.

The modified deep learning processing may be based on deep learning processing techniques such as those disclosed in the following publications: (1) Y. Bengio, “Learning Deep Architectures for AI”, Foundations and Trends in Machine Learning, vol. 2, no. 1, 2009; (2) G. Hinton, S, Osindero and Y. Teh, “A Fast Learning Algorithm for Deep Belief Nets”, Neural Computation, vol. 18, 2006; and (3) H. Lee, R. Grosse, R. Ranganath and A. Ng, “Convolutional Deep Belief Networks for Scalable Unsupervised Learning of Hierarchical Representations”, International Conference on Machine Learning, 2009. Each of the foregoing publications is hereby incorporated herein by reference in its entirety. The present disclosure, however, is not limited to such exemplary deep learning processing. Furthermore, as will be appreciated by one skilled in the art, some of the methods and systems disclosed herein may be practiced with processing techniques other than deep learning processing.

The foregoing deep learning processing techniques, or other processing techniques, may be modified to implement a hierarchy of filters. Each filter layer captures some of the information of the image data (represented by certain image descriptors), and then passes the remainder as well as a modified base signal to the next layer further up the hierarchy. Each of these filter layers may lead to progressively more abstract features (image descriptors) at high levels of the hierarchy. As a result, the learned feature (image descriptor) representations may be richer than existing hand-crafted image features like those of SIFT (disclosed in Lowe, David G. (1999). “Object recognition from local scale-invariant features”. Proceedings of the International Conference on Computer Vision. pp. 1150-1157 and U.S. Pat. No. 6,711,293, “Method and apparatus for identifying scale invariant features in an image and use of same for locating an object in an image”) and SURF (disclosed in Herbert Bay, Andreas Ess, Tinne Tuytelaars, Luc Van Gool “SURF: Speeded Up Robust Features”, Computer Vision and Image Understanding (CVIU), Vol. 110, No. 3, pp. 346-359, 2008), each of which publications and patent are hereby incorporated herein by reference in its entirety. This may enable easier extraction of useful information when building classifiers or other predictors.

The modified deep learning processing may utilize incremental learning, where an image representation can be easily updated as new data becomes available. This enables the modified deep learning processing technique to adapt without relearning when analyzing new image data.

The deep learning processing architecture may be based on a convolutional neural network (CNN). Such a convolutional neural network may be adapted to mimic a neocortex of a brain in a biological system. The convolutional neural network architecture, for example, may follow standard models of visual processing architectures for a primate vision system. Low-level feature extractors in the network may be modeled using convolutional operators. High-level object classifiers may be modeled using linear operators. Higher level features may be derived from the lower level features to form a hierarchical representation. The learned feature representations therefore may be richer by uncovering salient features across image scales, thus making it easier to extract useful information when building classifiers or other predictors.

By implementing convolutional filters in the lower-levels of the convolutional neural network, deep learning algorithms may reap substantial speedups by leveraging graphics processing unit (GPU) hardware based implementations. Thus, deep learning algorithms may effectively exploit large training sets, whereas traditional classification approaches scale poorly with training set size. Deep learning algorithms may perform incremental learning, where the representation may be easily updated as new images become available. A non-limiting example of incremental learning is disclosed in the following publication: C.-C. Chang and C.-J. Lin, “LibSVM: A library for Support Vector Machines”, ACM Transactions on Intelligent Systems and Technology, 2011, which publication is hereby incorporated herein by reference in its entirety. Even as image datasets (image data collections) grow, the modified deep learning processing of the present disclosure may not require the representation to be completely re-learned with each newly added image.

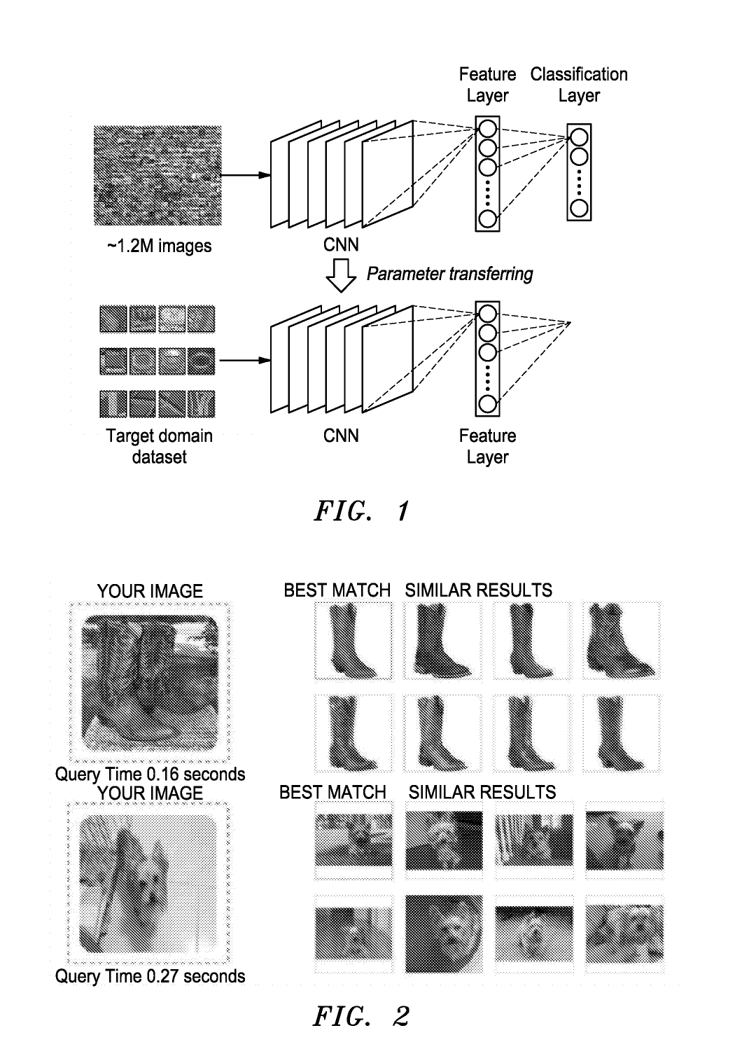

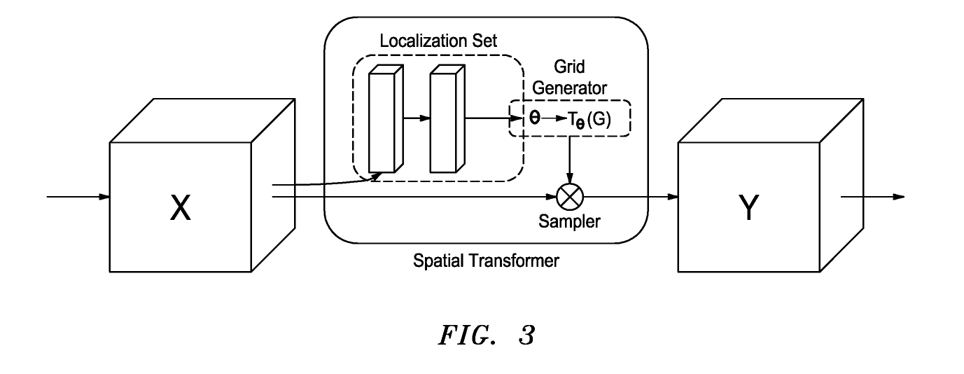

In practice, it may be difficult to obtain an image dataset of sufficient size to train an entire convolutional neural network from scratch. A common approach is to pre-train a convolutional neural network on a very large dataset, and then use the convolutional neural network either as an initialization or a fixed feature extractor for the task of interest. This technique is called transfer learning or domain adaptation and is illustrated in FIG. 1. The methods and systems of the present disclosure utilize this approach for a number of visual search applications as shown in FIG. 2.

To design a deep learning architecture, the present methods and systems may implement various transfer learning strategies. Examples of such strategies include, but are not limited to:
Treating the convolutional neural network as a fixed feature extractor: Given a convolutional neural network pre-trained on ImageNet, the last fully connected layer may be removed, then the convolutional neural network may be treated as a fixed feature extractor for the new dataset. ImageNet is a publicly available image dataset including 14,197,122 annotated images (disclosed in J. Deng, W. Dong, R. Socher, L. Li, and F-F. Li, “ImageNet: A Large Scale Hierarchical Image Database”, IEEE Conference on Computer Vision and Pattern Recognition, 2009), which publication is hereby incorporated by reference in its entirety. The result may be an N-D vector, known as a convolutional neural network code, which contains the activations of the hidden layer immediately before the classifier/output layer. The convolutional neural network code may then be applied to image classification or search tasks as described further below.
Fine-tuning the convolutional neural network: Given an already learned model, the architecture may be adapted and backpropagation training may be resumed from the already learned model weights. One can fine-tune all the layers of the convolutional neural network, or keep some of the earlier layers fixed (due to overfitting concerns) and then fine-tune some higher-level portion of the convolutional neural network. This is motivated by the observation that the earlier features of a convolutional neural network include more generic features (e.g., edge detectors or color blob detectors) that may be useful to many tasks, but later layers of the convolutional neural network becomes progressively more specific to the details of the classes contained in the original dataset.
Combining multiple convolutional neural networks and editing models: Given multiple individually trained models for different stages of the system, the different models may be combined into one single architecture by performing “net surgery”. Using net surgery techniques, layers and their parameters from one model may be copied and merged into another model, allowing results to be obtained with one forward pass, instead of loading and processing multiple models sequentially. Net surgery also allows editing model parameters. This may be useful in refining filters by hand, if required. It is also helpful in casting fully connected layers to fully convolutional layers to facilitate generation of a classification map for larger inputs instead of one classification result for the whole image.

The methods and systems of the present disclosure may utilize Caffe, which is an open-source implementation of a convolutional neural network. A description of Caffe can be found in the following publication: Y. Jia, E. Shelhamer, J. Donahue, S. Karayev, J. Long, R. Girshick, S. Guadarrama and T. Darrell, “Caffe: Convolutional Architecture for Fast Feature Embedding”, arXiv preprint arXiv: 1408.5093, 2014, which publication is hereby incorporated herein by reference in its entirety. Caffe's clean architecture may enable rapid deployment with networks specified as simple configuration files. Caffe features a GPU mode that may enable training at 5 ms/image and testing at 2 ms/image.

Prior to analyzing images represented by an image dataset, each image may be resized (or sub-window cropped) to a canonical size (e.g., 224×224). Each cropped image may be fed through the trained network, and the output at the first fully connected layer is extracted. The extracted output may be a 4096 dimensional feature vector representing the image and may serve as a basis for the image analysis. To facilitate this, well-established open-source libraries such as, but not limited to, LIBSVM and FLANN (Fast Library for Approximate Nearest Neighbors) may be used. An example of LIBSVM is described in the publication: C.-C. Chang and C.-J. Lin, “LibSVM: A library for Support Vector Machines”, ACM Transactions on Intelligent Systems and Technology, 2011. An example of FLANN is described in the publication: “FLANN—Fast Library for Approximate Nearest Neighbors”, http://www.sc.ubc.ca/research/flann/, which publication is hereby incorporated herein by reference in its entirety. Alternatively, the libraries may be generated specifically for the methods and systems of the present disclosure.

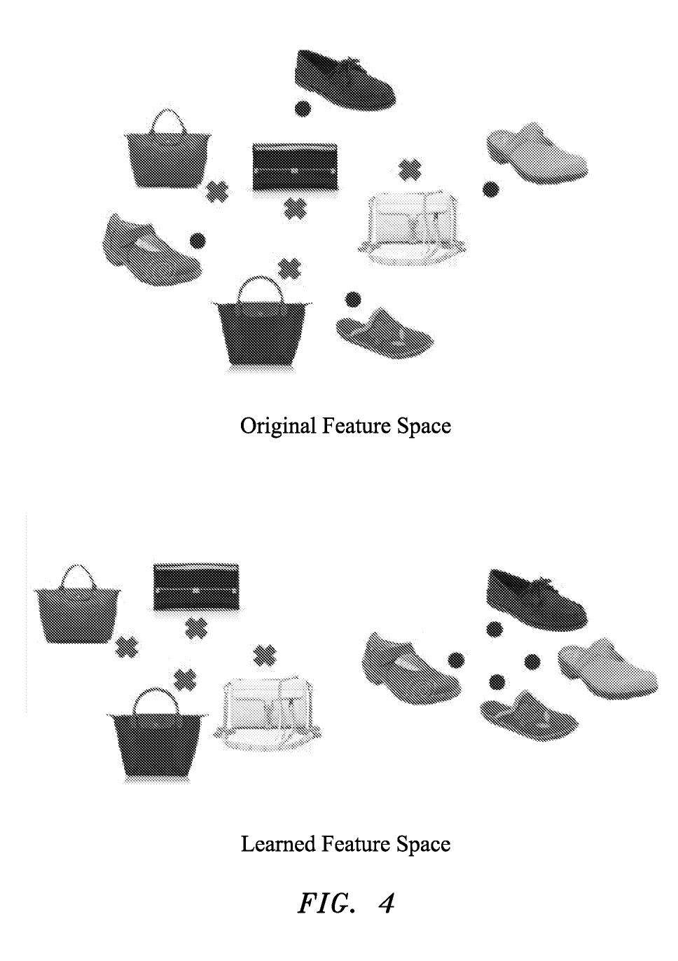

In order to handle geometric variations in images, a spatial transformer may be used. The spatial transformer module may result in models which learn translation, scale and rotation invariance. A spatial transformer is a module that learns to transformer feature maps within a network that correct spatially manipulated data without supervision. A description of spatial transformer networks can be found in the following publication: M. Jaderberg K. Simonyan A. Zisserman K. Kavukcuoglu, “Spatial Transformer Networks”, Advances in Neural Information Processing Systems 28 (NIPS), 2015, which publication is hereby incorporated herein by reference to its entirety. A spatial transformer may help localize objects, normalizing them spatially for better classification and representation for visual search. FIG. 3 illustrates the architecture of the module. The input feature map X is passed to a localization network which regresses the transformation parameters θ. The regular spatial grid G over V is transformed to the sampling grid T_{θ}(G), which is applied to the input X, producing the warped output feature map Y. The combination of the localization network and grid sampling mechanism make up a spatial transformer.

The convolutional neural network may be used for localization of objects of interest, by determining saliency regions in an input image. Output from filters in the last convolutional layer may be weighted with trained class specific weights between the following pooling and classification layers to generate activation maps for a particular class. Using saliency regions as cues to the presence of an object of interest, one may segment the object from a cluttered background, thus localizing it for further processing.

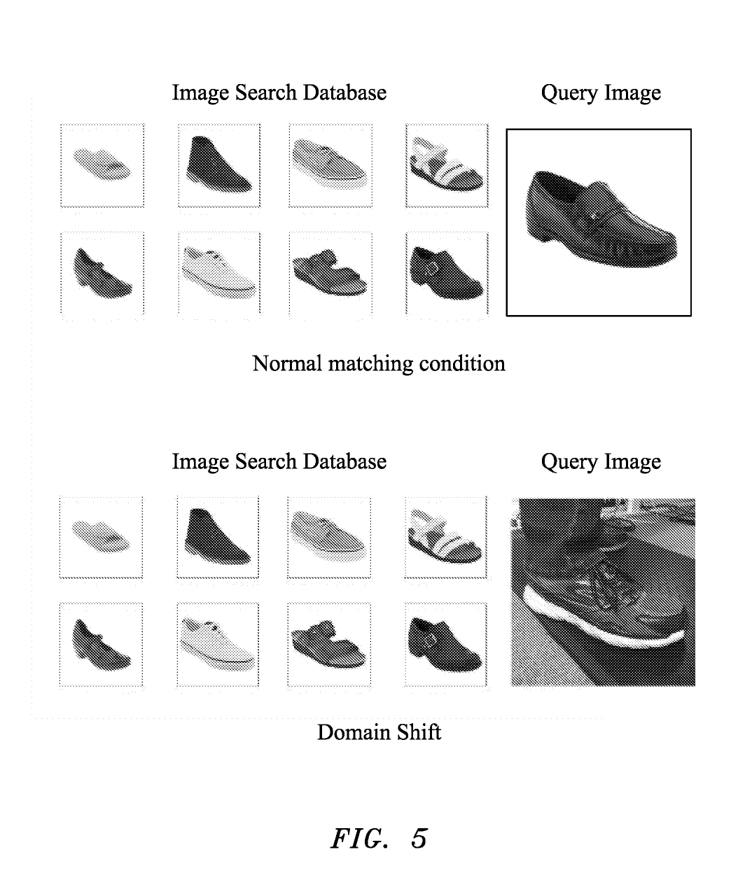

The features output by the convolution neural network may be tailored to new image search tasks and domains using a visual similarity learning algorithm. Provided labeled similar and dis-similar image pairs, this is accomplished by adding a layer to the deep learning architecture that applies a non-linear transformation of the features such that the distance between similar examples is minimized and that of dis-similar ones is maximized as illustrated in FIG. 4. The Siamese network learning algorithm may be used (Disclosed in S. Chopra, R. Hasdell, and Y. LeCun, “Learning a Similarity Metric Discriminatively, with Application to Face Verification”, In the Proceedings of CVPR, 2005, and R. Hadsell, S. Chopra and Y. LeCun, “Dimensionality Reduction by Learning an Invariant Mapping”. In the Proceedings of CVPR, 2006), each of which publication is hereby incorporated herein by reference in its entirety. This optimizes a contrastive loss function:

$$L ( W ) = \frac{1}{2 N} {\sum }_{n = 1}^{N} {y}_{n} {d ( {a}_{n} , {b}_{n} , W )}^{2} + ( 1 - {y}_{n} ) {max ( m - d ( {a}_{n} , {b}_{n} , W ) , 0 )}^{2}$$

where d=∥G(aₙ,W)−G(bₙ,W)∥₂, and yₙε{0,1} is the label for the image pair with features aₙ and bₙ, with yₙ=1 the label for similar pairs and yₙ=0 the label for dis-similar ones. G is a non-linear transformation of the input features with parameters W that are learned from the labeled examples. The margin parameter, m, decides to what extent to optimize dis-similar pairs.

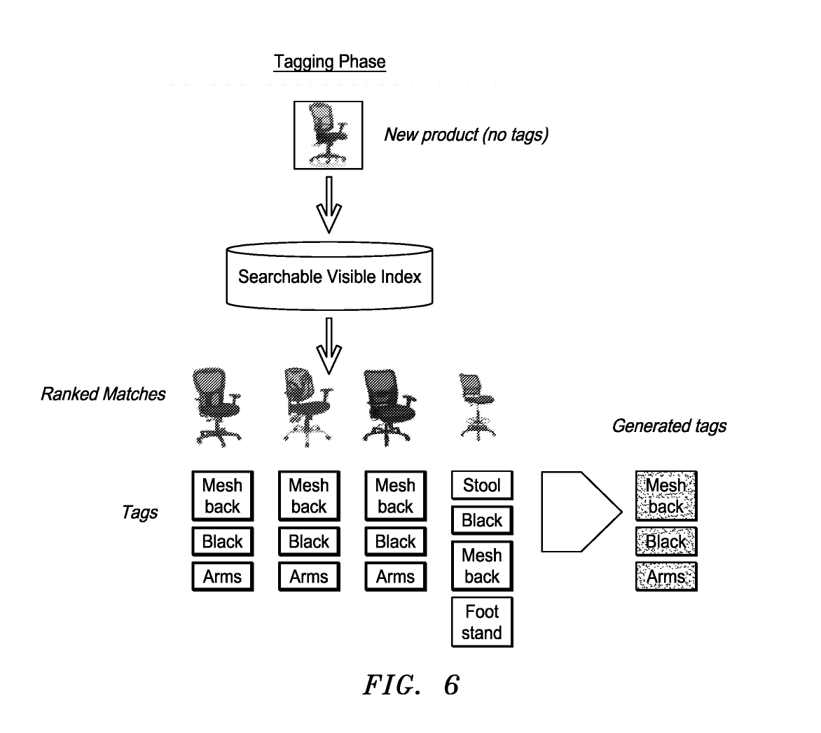

A visual similarity search can be performed within the same example set or across different imaging conditions. These two scenarios are depicted in FIG. 5. In the latter case, the image features computed for the working condition may not match those of the images to be searched. This problem is often referred to as domain shift (Disclosed in K. Saenko, B. Kulis, M. Fritz and T. Darrell, “Adapting Visual Category Models to New Domains”, In the Proceedings of ECCV, 2010), which publication is hereby incorporated herein by reference in its entirety. Domain adaptation seeks to correct the differences between the captured image features and those of the image database. Provided labeled image pairs, visual similarity learning may be used to perform domain adaptation and correct for domain shift. With this approach, a non-linear transformation is learned that maps the features from each domain into a common feature space that preserves relevant features and accounts for the domain shift between each domain.

The convolutional neural network may be used for image classification. In contrast to detection, classification may not require a localization of specific objects. Classification assigns (potentially multiple) semantic labels (also referred to herein as “tags”) to an image.

A classifier may be built for each category of interest. For example, a fine-tuned network may be implemented, where a final output layer corresponds to the class labels of interest. In another example, a classifier may be built based on convolutional neural network codes. To build such a classifier, the 4096 dimensional feature vector may be used in combination with a support vector machine (SVM). Given a set of labeled training examples, each marked as belonging to one of two categories, the support vector machine training algorithm may build a model that assigns new examples into one category or the other. This may make the classifier into a non-probabilistic binary linear classifier, for example. The support vector machine model represents examples as points in space, mapped so that the examples from separate categories are divided by a clear gap that is as wide as possible. New examples may then be mapped into that same space and predicted to belong to a category based on the side of the gap on which they fall. To enhance generalizability, the training set may be augmented by adding cropped and rotated samples of the training images. For classification scenarios where the semantic labels are not mutually exclusive, a one-against-all decision strategy may be implemented. Otherwise, a one-against-one strategy with voting may be implemented.

For a visual search task, the output of the first fully connected layer may be used as a feature representation. A dimensionality reduction step may be adopted to ensure fast retrieval speeds and data compactness. For all images, the dimensionality of the feature vector may be reduced from 4096 to 500 using principal component analysis (PCA).

Given the dimensionally reduced dataset, a nearest neighbor index may be built using the open-source library FLANN. FLANN is a library for performing fast approximate nearest neighbor searches in high dimensional spaces. FLANN includes a collection of algorithms for nearest neighbor searching and a system for automatically choosing a (e.g., “best”) algorithm and (e.g., “optimum”) parameters depending upon the specific image dataset. To search for the K-closest matches, a query may be processed as follows:
CNN representation→PCA dimensionality reduction→Search nearest neighbor index
   FIG. 2 illustrates image search applications on retail and animal imagery using deep learning.

In an alternative approach, a visual search may be implemented by applying an auto-coder deep learning architecture. Krizhevsky and Hinton applied an auto-encoder architecture to map images to short binary codes for a content-based image retrieval task. This approach is described in the following publication: A. Krizhevsky and G. Hinton, “Using Very Deep Autoencoders for Content-Based Image Retrieval”, European Symposium on Artificial Neural Networks, Computational Intelligence and Machine Learning, 2011, which publication is hereby incorporated herein by reference in its entirety. This system directly applied the auto-encoder to pixel intensities in the image. Using semantic hashing, 28-bit codes can be used to retrieve images that are similar to a query image in a time that is independent of the size of the database. For example, billions of images can be searched in a few milliseconds. The methods and system of the present disclosure may apply an auto-encoder architecture to the convolutional neural network representation rather than pixel intensities. It is believed that the convolutional neural network representation will be much better than the pixel intensities in capturing information about the kinds of objects present in the image.

Yet another approach is to learn a mapping of images to binary codes. This can be learned within a convolutional neural network by adding a hidden layer that is forced to output 0 or 1 by a sigmoid activation layer, before the classification layer. In this approach the model is trained to represent an input image with binary codes, which may then be used in classification and visual search.

The foregoing processes and techniques may be applied and expanded upon to provide various image analysis functionalities. These functionalities include, but are not limited to: Tagging; Visual Filtering/Visual Weighted Preferences; Visual Exemplars; and Smart Visual Browsing/Mental Image Search.

Tagging: Currently, categorization of product SKUs are manually accomplished by human labor. For example, when tagging shoes, a human observes an image of the shoe and then assign tags that describe the shoe such as “woman's”, “brown”, “sandal” and “strapless”. In contrast, the methods and the systems of the present disclosure may analyze an image of a product in real time and autonomously (e.g., automatically, without aid or intervention from a human) produce human readable tags similar to those tags assigned by a human. These tag(s) may then be displayed to a human for verification and corrections, as needed.

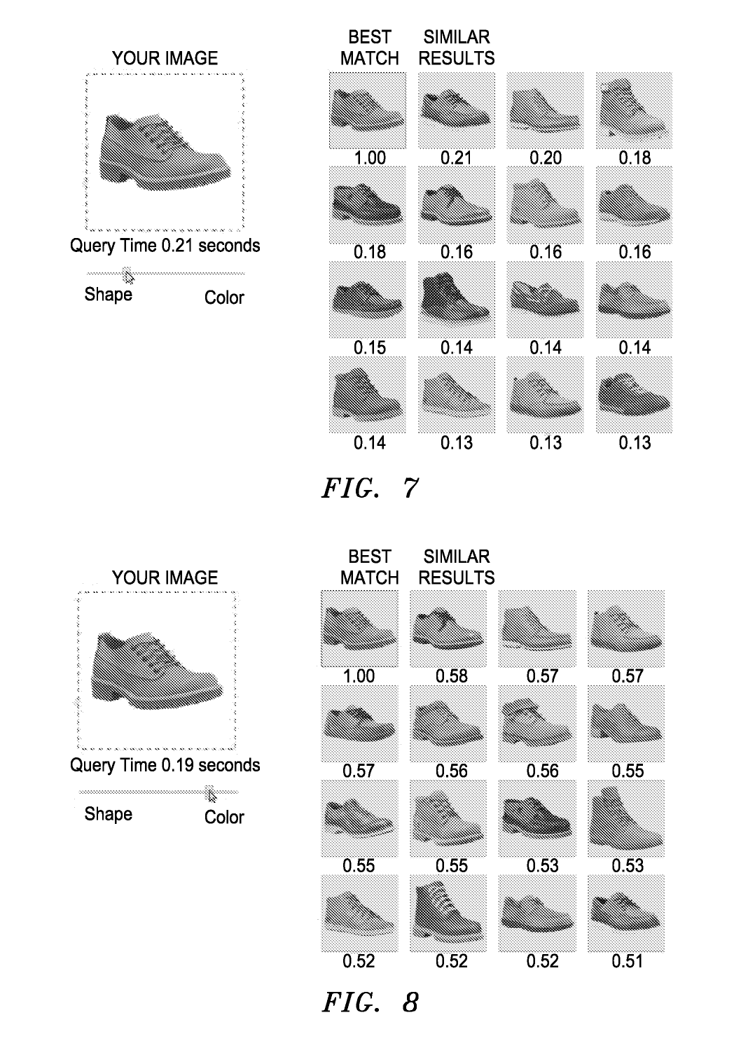

During this automated tagging process, tags are used that have been previously used in, for example, an eCommerce site. For example, the process may be performed to find similar images to a specimen image. Those similar images may each be associated with one or more pre-existing tags. Where those images share common tags, those common tags may be adopted to describe the specimen image. An example of this tagging process is visually represented in FIG. 6.

Visual Filtering/Visual Weighted Preferences: A product discovery process is provided to allow a user (e.g., a customer) on a website to browse a product inventory based on weighted attributes computed directly from the product images. A may also dynamically vary the importance of desired visual attributes.

Existing technologies may allow a consumer to filter through products based on visual attributes using facets. These facets are hand-labeled via human inspection. However, these technologies do not allow a user to define the degree of relative importance of one visual attribute over another. With current systems, a user cannot tune/filter search results by placing, for example, 80% importance on color and 20% on shape. In contrast, the product discovery process of the present disclosure allows for visually weighted preferences. The product discovery process also enables a user to filter search results based on personal tastes by allowing the user to weight the visual attributes most important to them.

The product discovery process enables a user (e.g., the customer) to visually browse a product inventory based on attributes computed directly from a specimen image. The process employs an algorithm that describes images with a multi-feature representation using visual qualities (e.g., image descriptors) such as color, shape and texture. Each visual quality (e.g., color, shape, texture, etc.) is weighted independently. For example, a color attribute can be defined as a set of histograms over the Hue, Saturation and Value (HSV) color values of the image. These histograms are concatenated into a single feature vector:

X_{HSV}=[w_{H}X_{H},w_{S}X_{S},w_{V}X_{V}].

Similarly, shape can be represented using shape descriptors such as a histogram of oriented gradients (HOG) or Shape Context.

The shape and color feature vectors may then each be normalized to unit norm, and weighted and concatenated into a single feature vector:

X=[w₁X₁, . . . ,wₙXₙ],

where Xᵢ is the unit normalized feature vector from the i-th visual quality and wᵢ is its weight.

Feature comparison between the concatenated vectors may be accomplished via distance metrics such as, but not limited to, Chi Squared distance or Earth Mover's Distance to search for images having similar visual attributes:

$${d}_{χ2} ( {X}_{i} , {X}_{j} ) = {\sum }_{k} {( {X}_{i} ( k ) - {X}_{j} ( k ) )}^{2} / ( {X}_{i} ( k ) + {X}_{j} ( k ) ) .$$

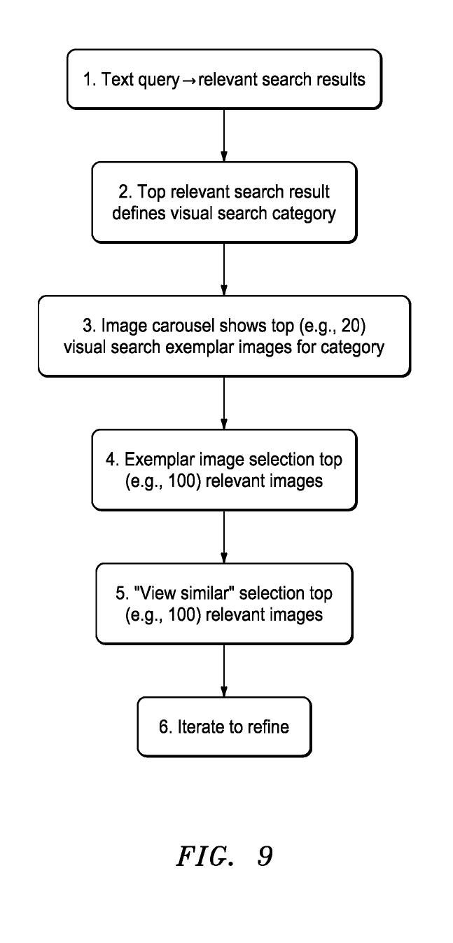

The weighting parameter (w) reflects the preference for a particular visual attribute. This parameter can be adjusted via a user-interface that allows the user to dynamically adjust the weighting of each feature vector and interactively adjust the search results based on their personal preference. FIGS. 7 and 8 illustrate screenshot examples of re-ranking search results based on color and shape. In FIG. 7, weighting preference is on shape over color. In FIG. 8, weighting preference is on color over shape.

Visual Exemplars: On e-commerce websites, product images within a search category may be displayed in an ad-hoc or random fashion. For example, if a user executes a text query, the images displayed in the image carousel are driven by a keyword-based relevancy, resulting in many similar images. In contrast, the methods of the present disclosure may analyze the visual features/image descriptors (e.g., color, shape, texture, etc.) to determine “exemplar images” within a product category. An image carousel populated with “exemplar images” better represents the breadth of the product assortment. The term “exemplar image” may be defined as being at the “center of the cluster” of relevant image groups. For example, an exemplar image may be an image that generally exemplifies features of other images in a grouping; thus, the exemplar image is an exemplary one of the images in the grouping.

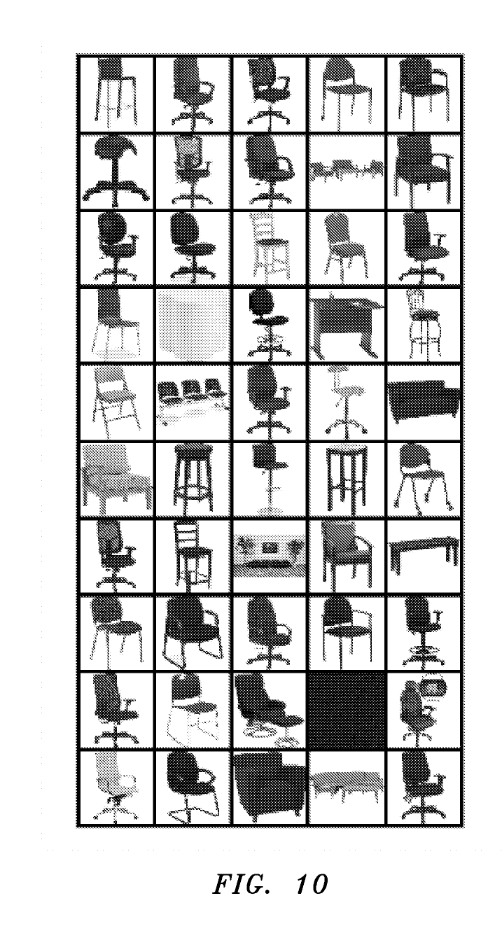

The visual exemplar processing may provide a richer visual browsing experience for a user by displaying the breadth of the product assortment, thereby facilitating product discovery. This process can bridge the gap between text and visual search. The resulting clusters can also allow a retailer or other entity to quickly inspect mislabeled products. Furthermore, manual SKU set up may not be needed in order to produce results. An exemplary method using visual exemplar processing is shown in FIG. 9.

Visual cluster analysis may group image objects based (e.g., only) on visual information found in images that describes the objects and their relationships. Objects within a group should be similar to one another and different from the objects in other groups. A partitional clustering approach such as, but not limited to, K-Means may be employed. In this scheme, a number of clusters K may be specified a priori. K can be chosen in different ways, including using another clustering method such as, but not limited to, an Expectation Maximization (EM) algorithm, running the algorithm on data with several different values of K, or use the prior knowledge about the characteristics of the problem. Each cluster is associated with a centroid or center point. Each point is assigned to the cluster with the closest centroid. Each image is represented by a feature (e.g., a point) which might include the multi-channel feature described previous, a SIFT/SURF feature, or color histogram or a combination thereof.

In an exemplary embodiment, the algorithm is as follows:
1. Select K points as the initial centroids. This selection is accomplished by randomly sampling dense regions of the feature space.
2. Loop
   a. Form K clusters by assigning all points to the closest centroid. The centroid is typically the mean of the points in the cluster. The “closeness” is measured according to a similarity metric such as, but not limited to, Euclidean distance, cosine similarity, etc. The Euclidean distance is defined as:

d(i,j)=\sqrt{|xᵢ₁−xⱼ₁|²+|xᵢ₂−xⱼ₂|²+ . . . +|xᵢₚ−xⱼₚ|²}
b. Re-compute the centroid of each cluster. The following equation may be used to calculate the n-dimensional centroid point amid k n-dimensional points:

$$CP ( {x}_{1} , … , {x}_{k} ) = ( \frac{{\sum }_{i = 1}^{k} x 1 st}{k} , \frac{{\sum }_{i = 1}^{k} x 2 nd}{k} , … , \frac{{\sum }_{i = 1}^{k} xnth}{k} )$$

3. Repeat until the centroids do not change.
   Once the clustering is complete, various methods may be used to assess the quality of the clusters. Exemplary methods are as follows:
1. The diameter of the cluster versus the inter-cluster distance;
2. Distance between the members of a cluster and the cluster's center; and
3. Diameter of the smallest sphere.
   Of course, the present disclosure is not limited to the foregoing exemplary methods.

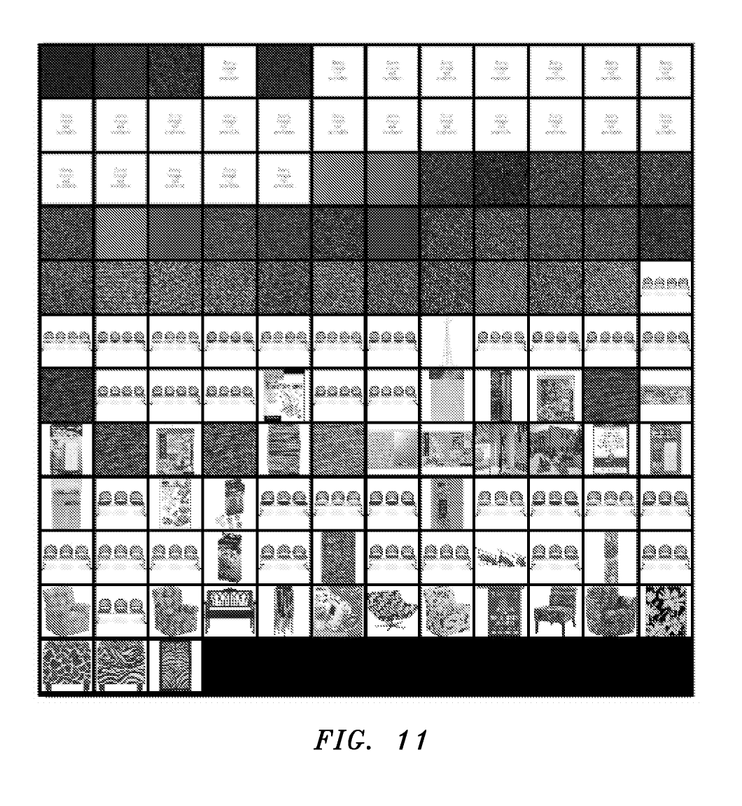

FIG. 10 illustrates an example of visual clustering of office chairs into 50 clusters. Each image cell represents the exemplar of a cluster. These exemplars may be visually presented to a user to initiate visual search/filtering enhancements to the browsing experience and facilitate product discovery.

FIG. 11 illustrates how visual clustering allows a retailer (or other entity) to quickly ensure quality control/assurance of their product imagery. These images are members of cluster 44 in FIG. 8. Some members of this cluster represent mislabeled chair product images.

FIG. 12 illustrates images representing members of cluster 20 from FIG. 10. The exemplar is the first cell (upper left corner) in the image matrix. The other remaining cells may be sorted (left to right, top to bottom) based on visual similarity (distance in feature space) from the exemplar.

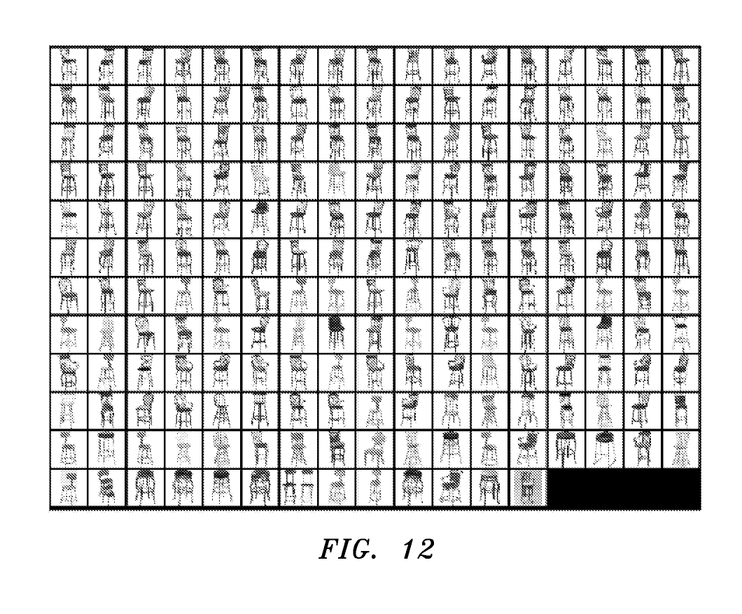

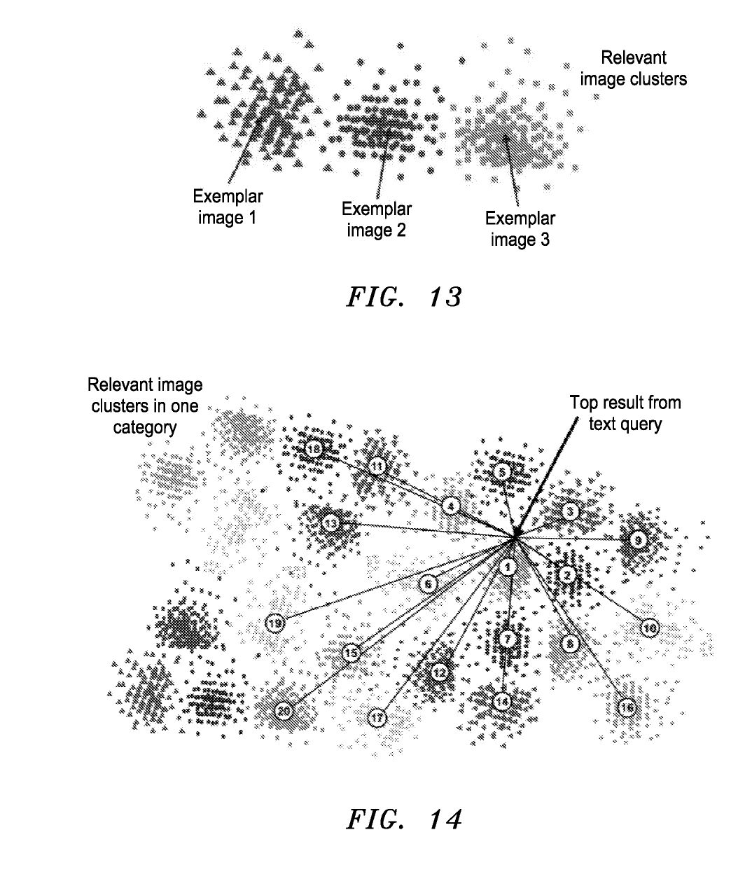

FIG. 13 illustrates a conceptual visualization of an output after visual clustering. FIG. 14 illustrates a conceptual visualization of how a visual search can be combined with text based queries.

Smart Visual Browsing/Mental Image Search: A common method to visual shopping relies on a customer/user provided input image to find visually similar examples (also known as query by example). However, in many cases, the customer may not have an image of the item that they would like to buy, either because they do not have one readily available or are undecided on the exact item to purchase. The smart visual browsing method of the present disclosure will allow the customer to quickly and easily browse a store's online inventory based on a mental picture of their desired item. This may be accomplished by allowing the customer to select images from an online inventory that closely resemble what they are looking for and visually filtering items based on the customer's current selections and browsing history. Smart visual browsing has the potential to greatly reduce search time and can lead to a better overall shopping (or other searching) experience than existing methods based on a single input image.

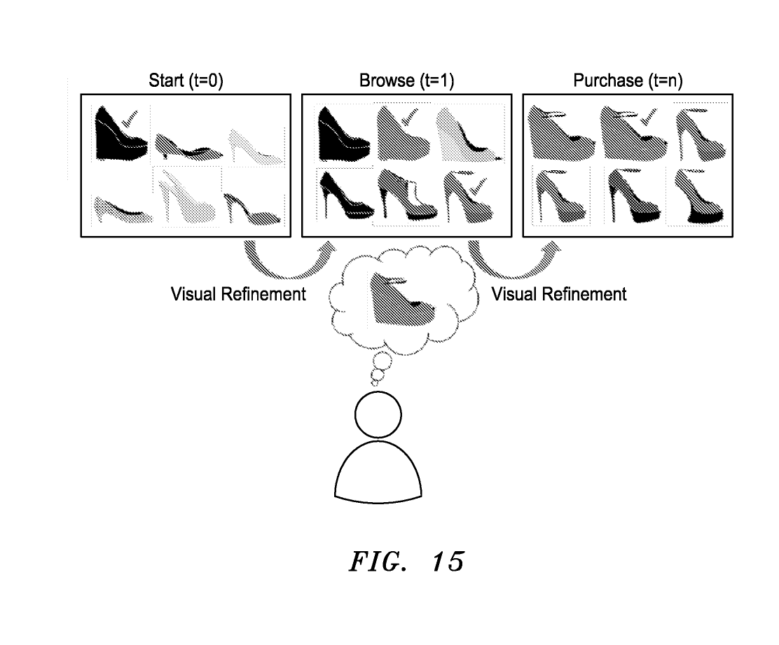

A schematic of smart visual browsing is shown in FIG. 15. Here, a customer is presented with a set of images from a store's inventory. The customer may then select one or more images that best represent the mental picture of the item they want to buy. The search results are refined and this process is repeated until the customer either finds what they want, or stops searching.

Using smart visual browsing, a customer may be guided to a product/image the customer is looking for or wants with as few iterations as possible. This may be accomplished by iteratively refining the search results based on both the customer's current selection and his/her browsing history. This browsing may utilize the PicHunter method of Cox et al., 2000, which is adapt for the purposes of visual shopping.

Using Bayes rule, the posterior probability of an inventory image, Tᵢ, may be defined as being the target image, T, at iteration t as:

P(T=Tᵢ|Hₜ)=P(Hₜ|T=Tᵢ)P(T=Tᵢ)/P(Hₜ),

where Hₜ={D₁, A₁, D₂, A₂, . . . , Dₜ, Aₜ} is the history of customer actions, Aⱼ, and displayed images, Dⱼ, from the previous iterations.

The prior probability P(T=Tᵢ) may define the initial belief that inventory image Tᵢ is the target in the absence of any customer selections. This can be set simply as the uniform distribution (e.g., all images may be equally likely), and/or from textual attributes provided by the user (e.g., the user clicks on ‘shoes’ and/or a visual clustering of the inventory items).

The posterior probability may be computed in an iterative manner with respect to P(T=Tᵢ|Hₜ₋₁), resulting in the following Bayesian update rule:

$$\begin{matrix}P ( T = {T}_{i} \vert {H}_{t} ) = P ( T = {T}_{i} \vert {D}_{t} , {A}_{t} , {H}_{t - 1} ) \\ = P ( {A}_{t} \vert T = {T}_{i} , {D}_{t} , {H}_{t - 1} ) P ( T = {T}_{i} \vert {H}_{t - 1} ) / P ( {A}_{t} \vert {D}_{t} , {H}_{t - 1} ) ,\end{matrix}$$

$$and$$

$$P ( {A}_{t} \vert {D}_{t} , {H}_{t - 1} ) = {\sum }_{j} P ( {A}_{t} \vert T = {T}_{j} , {D}_{t} , {H}_{t - 1} ) P ( T = {T}_{j} \vert {H}_{t - 1} ) .$$

The term P(Aₜ|T=Tⱼ,Dₜ,Hₜ₋₁) is referred to as the customer model that is used to predict the customer's actions and update the model's beliefs at each iteration. The images A shown at each iteration are computed as the most likely examples under the current model.

This method may have two customer models: relative and absolute. The relative model will allow the user to select multiple images per set of items, and is computed as:

P(A={a₁, . . . ,aₖ}|D={X₁, . . . ,Xₙ},T)=Πᵢ P(A=aᵢ|Xₐ_{ᵢ},Xᵤ,T),

where D={X₁, . . . , Xₙ} is the set of displayed images, aᵢ is the action of selecting image Xₐ_{ᵢ}, Xᵤ=D\{Xₐ_{ᵢ},Xₐ_{ₖ}} is the set of unselected images, and T is the assumed target inventory image.

The marginal probabilities over individual actions aᵢ may be computed using a product of sigmoids:

$$P ( A = a \vert {X}_{a} , {X}_{u} , T ) = {\prod }_{i} 1 / ( 1 + exp ( ( d ( {X}_{a} , T ) - d ( {X}_{{u}_{i}} , T ) ) / σ ) ) ,$$

where d(•) is a visual distance measure computed that can combine several attributes including color and shape.

The absolute model allows the customer to (e.g., only) select a single image at each iteration:

P(A=a|D,T)=G(d(Xₐ,T)),

where G(•) is any monotonically decreasing function between 1 and 0.

Both customer models may re-weight the posterior probability based on the customer's selection to present the customer with a new set of images at the next iteration that more closely resemble the product that they are searching for. This may be used to more rapidly guide the user to relevant products compared with conventional search techniques based on text-only and/or single image queries.

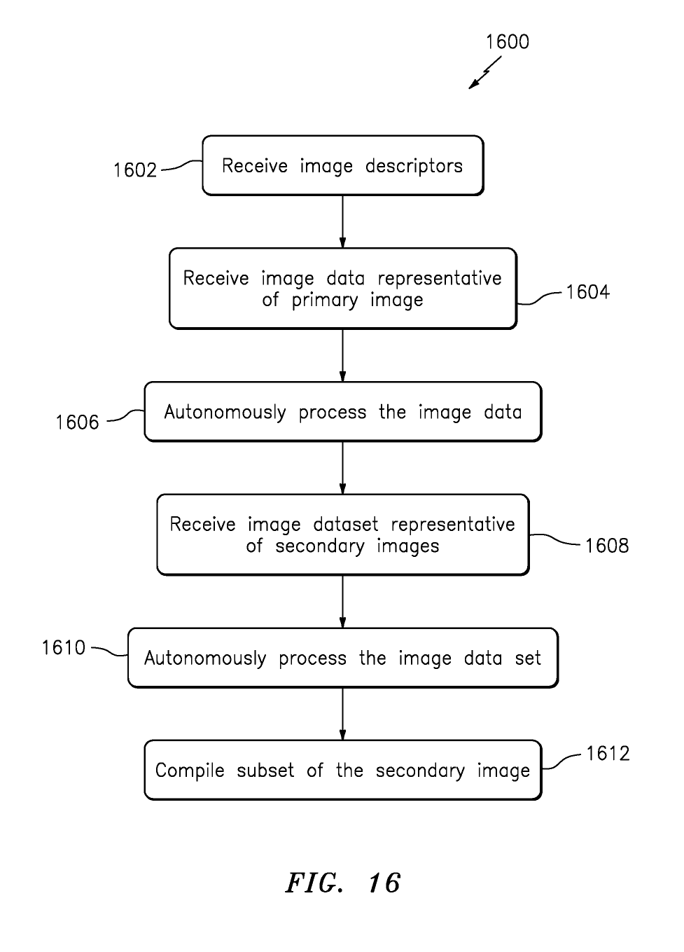

FIG. 16 is a flow diagram of a method 1600 which may incorporate one or more of the above-described aspects of the present disclosure. This method 1600 is described below with reference to a retail application. However, the method 1600 is not limited to this exemplary application.

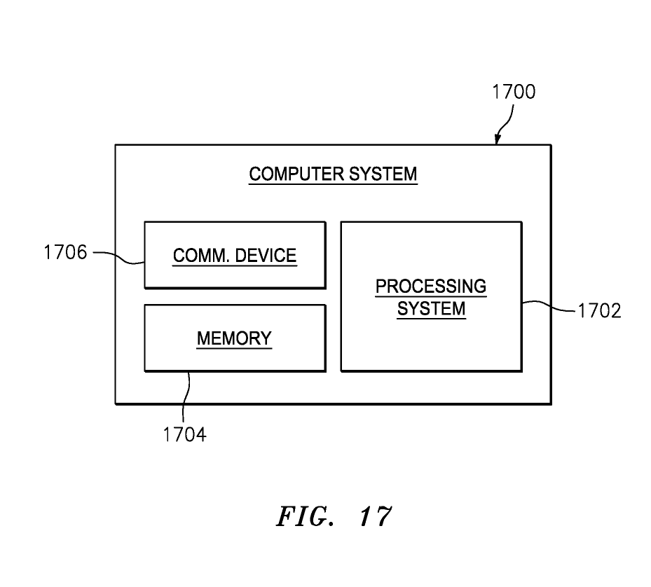

The method 1600 is described below as being performed by a computer system 1700 as illustrated in FIG. 17. However, the method 1600 may alternatively be performed using other computer system configurations. Furthermore, the method 1600 may also be performed using multiple interconnected computer systems; e.g., via “the cloud”.

The computer system 1700 of FIG. 17 may be implemented with a combination of hardware and software. The hardware may include a processing system 1702 (or controller) in signal communication (e.g., hardwired and/or wirelessly coupled) with a memory 1704 and a communication device 1706, which is configured to communicate with other electronic devices; e.g., another computer system, a camera, a user interface, etc. The communication device 1706 may also or alternatively include a user interface. The processing system 1702 may include one or more single-core and/or multi-core processors. The hardware may also or alternatively include analog and/or digital circuitry other than that described above.

The memory 1704 is configured to store software (e.g., program instructions) for execution by the processing system 1702, which software execution may control and/or facilitate performance of one or more operations such as those described in the methods above and below. The memory 1704 may be a non-transitory computer readable medium. For example, the memory 1704 may be configured as or include a volatile memory and/or a nonvolatile memory. Examples of a volatile memory may include a random access memory (RAM) such as a dynamic random access memory (DRAM), a static random access memory (SRAM), a synchronous dynamic random access memory (SDRAM), a video random access memory (VRAM), etc. Examples of a nonvolatile memory may include a read only memory (ROM), an electrically erasable programmable read-only memory (EEPROM), a computer hard drive, etc.

Referring again to FIG. 16, in step 1602, a plurality of image descriptors (e.g., features or terms) are received. These image descriptors may be received through the communication device 1706 before or during the performance of the method 1600. Each of these image descriptors represents a unique visual characteristic. For example, a descriptor may represent a certain color, a certain texture, a certain line thickness, a certain contrast, a certain pattern, etc.

In step 1604, image data is received. This image data may be received through the communication device 1706 before or during the performance of the method 1600. The image data is representative of a primary (or specimen) image. This primary image is the image with which the image analysis is started; the base image being analyzed/investigated.

In step 1606, the image data is autonomously processed by the computer system 1700 (e.g., without aid of a human, the user) to select a first subset of the image descriptors. This first subset of the image descriptors represent a plurality of visual characteristics of the primary image. This first subset should not include any of the image descriptors which do not represent a visual characteristic of the primary image. For example, if the primary image is in black and white, or gray tones, the computer system 1700 may not select a color descriptor. In another example, if the primary image as not shape defined lines, the computer system 1700 may not select a line descriptor. Thus, when the computer system 1700 later searches for images with image descriptors in the first subset, the computer system 1700 does not waste time reviewing image descriptors that do not relate to the primary image.

In step 1608, an image dataset is received. This image dataset may be received through the communication device 1706 before or during the performance of the method 1600. The image dataset is representative of a plurality of secondary (e.g., to-be-searched) images. More particularly, the image dataset includes a plurality of sets of image data, each of which represents a respective one of the secondary images. The secondary images represent the images the method 1600 searches through and visually compares to the primary image.

In step 1610, the image dataset is autonomously processed by the computer system 1700 to determine which of the secondary images is/are visually similar to the primary image. For example, the computer system 1700 may analyze each of the secondary images in a similar manner as the primary image to determine if that secondary image is associated with one or more of the same image descriptors as the primary image. Alternatively, where a secondary image is already associated with one or more image descriptors, the computer system 1700 may review those image descriptors to determine if they are the same as those in the first subset of the image descriptors for the primary image.

The computer system 1700 may determine that one of the secondary images is similar to the primary image where both images are associated with at least a threshold (e.g., one or more) number of common image descriptors. In addition or alternatively, the computer system 1700 may determine that one of the secondary images is similar to the primary image where both images are associated with a certain one or more (e.g., high weighted) image descriptors.

In step 1612, the computer system 1700 compiles a subset of the secondary images. This subset of the secondary images includes the images which were determined to be similar to the primary image. The subset of the secondary images may then be visually presented to a user (e.g., a consumer) to see if that consumer is interested in any of those products in the images. Where the consumer is interested, the consumer may select a specific one of the images via a user interface in order to purchase, save, etc. the displayed product. Alternatively, the consumer may select one or more of the product images that are appealing, and the search process may be repeated to find additional similar product images.

In some embodiments, the computer system 1700 may autonomously determine a closest match image. This closest match image may be one of the secondary images that is visually “most” similar to the primary image based on the first subset of the image descriptors. For example, the closest match images may be associated with more of the first subset of the image descriptors than any other of the secondary images. In another example, the closest match image may be associated with more of the “high” weighted image descriptors in the first subset than any other of the secondary images, etc. The method 1600 may subsequently be repeated with the closest match image as the primary image to gather additional visually similar images. In this manner, additional product images may be found based on image descriptors not in the original first set. This may be useful, for example, where the consumer likes the product depicted by the closest match image better than the product depicted by the primary image.

In some embodiments, the user (e.g., consumer) may select one or more of the subset of the secondary images, for example, as being visually appealing, etc. The computer system 1700 may receive this selection. The computer system 1700 may then autonomously select a second subset of the image descriptors that represent a plurality of visual characteristics of the selected secondary image(s). The computer system 1700 may then repeat the analyzing steps above to find additional visually similar images to the secondary images selected by the consumer.

In some embodiments, the user (e.g., consumer) may select one or more of the subset of the secondary images, for example, as being visually appealing, etc. The computer system 1700 may receive this selection. The computer system 1700 may autonomously select a second subset of the image descriptors that represent a plurality of visual characteristics of the selected secondary image(s). The computer system 1700 may then autonomously analyze that second subset of the image descriptors to look for commonalities with the first set of image descriptors and/or between commonalities between image descriptors associated with the selected secondary images. Where common image descriptors are found, the computer system 1700 may provide those image descriptors with a higher weight. In this manner, the computer system 1700 may autonomously learn from the consumer's selections and predict which additional images will be more appealing to the consumer.

In some embodiments, the computer system 1700 may review tags associated with the subset of the secondary images. Where a threshold number of the subset of the secondary images are associated with a common tag, the computer system 1700 may autonomously associate that tag with the primary image. In this manner, the computer system 1700 may autonomously tag the primary image using existing tags.

In some embodiments, each of the subset of the secondary images may be an exemplar. For example, each of the subset of the secondary images may be associated with and exemplary of a plurality of other images. Thus, where a user (e.g., consumer) selects one of those exemplars, the represented other images may be displayed for the user, or selected for another search.

In some embodiments, the image descriptors may be obtained from a first domain. In contrast, the primary image may be associated with a second domain different from the first domain. For example, the computer system 1700 may use image descriptors which have already been generated for furniture to analysis a primary image of an animal or insect. Of course, the present disclosure is not limited to such an exemplary embodiment.

In some embodiments, the computer system 1700 may autonomously determine a closest match image. This closest match image may be one of the secondary images that is visually “most” similar to the primary image based on the first subset of the image descriptors. The processing system 1702 may then autonomously identify the primary image based on a known identity of the closest match image, or otherwise provide information on the primary image. This may be useful in identifying a particular product a consumer is interested in. This may be useful where the primary image is of a crop, insect or other object/substance/feature the user is trying to identify or learn additional information about.

In some embodiments, the primary image may be of an inanimate object; e.g., a consumer good. In some embodiments, the primary image may be of a non-human animate object; e.g., a plant, an insect, an animal such as a dog or cat, a bird, etc. In some embodiments, the primary image may be of a human.

The systems and methods of the present disclosure may be used for various applications. Examples of such applications are provided below. However, the present disclosure is not limited to use in the exemplary applications below.

Government Applications: The image processing systems and methods of the present disclosure may facilitate automated image-based object recognition/classification and is applicable to a wide range of Department of Defense (DoD) and intelligence community areas, including force protection, counter-terrorism, target recognition, surveillance and tracking. The present disclosure may also benefit several U.S. Department of Agriculture (USDA) agencies including Animal and Plant Health Inspection Service (APHIS) and Forest Service. The National Identification Services (NIS) at APHIS coordinates the identification of plant pests in support of USDA's regulatory programs. For example, the Remote Pest Identification Program (RPIP) already utilizes digital imaging technology to capture detailed images of suspected pests which can then be transmitted electronically to qualified specialists for identification. The methods and systems of the present disclosure may be used to help scientists process, analyze, and classify these images.

The USDA PLANTS Database provides standardized information about the vascular plants, mosses, liverworts, homworts, and lichens of the United States and its territories. The database includes an image gallery of over 50,000 images. The present disclosure's image search capability may allow scientists and other users to easily and efficiently search this vast image database by visual content. The Forest Service's Inventory, Monitoring & Analysis (IMA) research program provides analysis tools to identify current status and trends, management options and impacts, and threats and impacts of insects, disease, and other natural processes on the nation's forests and grassland species. The present disclosure's image classification methods may be adapted to identify specific pests that pose a threat to forests, and then integrate them into inventory and monitoring applications.

Commercial Application: Online search tools initiated an estimated $175B worth of domestic e-commerce in 2015. Yet 39% of shoppers believe the biggest improvement retailers need to make is in the process of selecting goods, also known as product discovery. Recent advances in machine learning and computer vision have opened up a new paradigm for product discovery—“visual shopping”. The present disclosure can enable answering common questions that require a visual understanding of products such as, but not limited to, “I think I like this [shoe, purse, chair] . . . can you show me similar items?” By answering “visual” questions accurately and consistently, the present disclosure's visual search engine may instill consumer confidence in online shopping experiences, yielding increased conversions and fewer returns.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A method for processing image data using a computer system, comprising:
receiving a plurality of image descriptors, each of the image descriptors representing a unique visual characteristic;
receiving image data representative of a primary image;
processing the image data to select a first subset of the image descriptors that represent a plurality of visual characteristics of the primary image;
receiving an image dataset representative of a plurality of secondary images; and
processing the image dataset based on the first subset of the image descriptors to determine which of the secondary images are visually similar to the primary image;
wherein the processing of the image data and the image dataset is autonomously performed by the computer system.

2. The method of claim 1, wherein the image descriptors not included in the first subset of the image descriptors form a second subset of the image descriptors, and the second subset of the image descriptors are not considered in the processing of the image dataset.

3. The method of claim 2, wherein none of the second subset of the image descriptors represent a visual characteristic of the primary image.

4. The method of claim 1, wherein the secondary images include a second image, and the processing of the image dataset comprises determining whether any of the first subset of the image descriptors represents a visual characteristic of the second image.

5. The method of claim 4, wherein the second image is determined to be visually similar to the primary image where at least a threshold number of the first subset of the image descriptors represent respective visual characteristics of the second image.

6. The method of claim 4, wherein the second image is determined to be visually similar to the primary image where at least a select one of the first subset of the image descriptors represent a visual characteristic of the second image.

7. The method of claim 1, further comprising:
autonomously determining a closest match image, the closest match image being one of the secondary images that is visually most similar to the primary image based on the first subset of the image descriptors;
autonomously processing a portion of the image dataset corresponding to the closest match image to select a second subset of the image descriptors that represent a plurality of visual characteristics of the closest match image; and
autonomously processing the second subset of the image descriptors to find one or more additional images that are visually similar to the closest match image.

8. The method of claim 7, wherein the second subset of the image descriptors includes at least one of the image descriptors not included in the first subset of the image descriptors.

9. The method of claim 1, further comprising:
compiling a subset of the secondary images that are determined to be visually similar to the primary image;
receiving a selection of a second image that is one of the subset of the secondary images;
autonomously selecting a second subset of the image descriptors that represent a plurality of visual characteristics of the second image; and
autonomously processing the second subset of the image descriptors to find one or more additional images that are visually similar to the second image.

10. The method of claim 1, further comprising:
compiling a subset of the secondary images that are determined to be visually similar to the primary image;
receiving a selection of a second image and a third image, the second image being one of the subset of the secondary images, and the third image being another one of the subset of the secondary images;
autonomously selecting a second subset of the image descriptors that represent a plurality of visual characteristics of the second image;
autonomously selecting a third subset of the image descriptors that represent a plurality of visual characteristics of the third image;
autonomously determining a common image descriptor between the second subset and the third subset of the image descriptors; and
providing the common image descriptor with a higher weight than another one of the second subset and the third subset of the image descriptors during further processing.

11. The method of claim 1, further comprising:
compiling a subset of the secondary images that are determined to be visually similar to the primary image, wherein the subset of the secondary images are pre-associated with a plurality of classification tags; and
autonomously selecting and associating the primary image with at least one of the classification tags.

12. The method of claim 1, further comprising:
compiling a subset of the secondary images that are determined to be visually similar to the primary image, wherein each of the subset of the secondary images is associated with and is an exemplar of one or more other images;
receiving a selection of a second image that is one of the subset of the secondary images; and
providing data indicative of the second image and the associated one or more of the other images of which the second image is an exemplar.

13. The method of claim 1, wherein the image descriptors were developed for a first domain, and the primary image is associated with a second domain that is different than the first domain.

14. The method of claim 1, wherein the primary image is a photograph of an inanimate object.

15. The method of claim 1, wherein the primary image is a photograph of a non-human, animate object.

16. The method of claim 1, further comprising:
autonomously determining a closest match image, the closest match image being one of the secondary images that is visually most similar to the primary image based on the first subset of the image descriptors; and
identifying a feature in the primary image based on a known identity of a visually similar feature in the closest match image.

17. The method of claim 16, further comprising retrieving information associated with the known identity.

18. A method for processing image data using a computer system and a plurality of image descriptors, each of the image descriptors representing a unique visual characteristic, the method comprising:
autonomously processing image data, using the computer system, to select a first subset of the image descriptors that represent a plurality of visual characteristics of a primary image, the image data representative of the primary image;
obtaining an image dataset representative of a plurality of secondary images; and
autonomously processing the image dataset, using the computer system, to determine a subset of the secondary images, the subset of the secondary images provided based on the first subset of the image descriptors, wherein the subset of the secondary images are visually similar to the primary image.

19. A computer system for processing image data, comprising:
a processing system; and
a non-transitory computer-readable medium in signal communication with the processing system, the non-transitory computer-readable medium having encoded thereon computer-executable instructions that when executed by the processing system enable:
receiving a plurality of image descriptors, each of the image descriptors representing a unique visual characteristic;
receiving image data representative of a primary image;
autonomously processing the image data to select a first subset of the image descriptors that represent a plurality of visual characteristics of the primary image;
receiving an image dataset representative of a plurality of secondary images; and
autonomously processing the image dataset based on the first subset of the image descriptors to determine which of the secondary images are visually similar to the primary image.

20. The computer system of claim 19, wherein the secondary images include a second image, and the processing of the image dataset comprises determining whether any of the first subset of the image descriptors represents a visual characteristic of the second image.
